(19) United States
(12) Patent Application Publication
(10) Pub. No.: US 2007/0224484 A1
(43) Pub. Date: Sep. 27, 2007

(54) Fuel cell and equipment with the same

(76) Inventors: Tomoichi Kamo, Tokai (JP); Masayoshi Kanno, Kitaibaraki (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/589,097

(22) Filed: Oct. 30, 2006

(30) Foreign Application Priority Data
Mar. 27, 2006 (JP) 2006-084448

(51) Int. Cl. H01M 8/04

(52) U.S. Cl. 429/34; 429/25

(57) ABSTRACT

A fuel cell comprises a fuel vessel, a unit cell, a fuel transport member. The fuel vessel is formed with a fuel chamber section for retaining a liquid fuel and a fuel tank section for supply the fuel to the fuel chamber section. The unit cell is placed on the fuel chamber section so that the fuel is fed from the fuel chamber section. The fuel transport member has first pores for retaining the fuel by a capillary attraction and second pores allowing the passage of a gas by not retaining the fuel. The fuel transport is placed in the fuel chamber section. A fuel-gas exchange section is provided between the fuel chamber section and the fuel tank section to lead the gas in the fuel chamber into the fuel tank section and to lead the fuel in the fuel tank section into the fuel chamber section. A vent hole is provided to a wall of the fuel chamber section to exhaust the gas in the fuel chamber section.

### CLAIM OF PRIORITY

The present application claims priority from Japanese application serial no. 2006-84448, filed on Mar. 27, 2006, the content of which is hereby incorporated by reference into this application.

### FIELD OF THE INVENTION

The present invention relates to a fuel cell of feeding a liquid fuel to an anode for electric power generation.

### BACKGROUND OF THE INVENTION

A polymer electrolyte membrane fuel cell (PEM-FC) type power generation system is generally comprised of: unit cells each having porous an anode and a cathode on both sides of a polymer electrolyte membrane; a fuel container, a fuel feeder, and an air or oxygen feeder. The cells are connected to each other in series and, optionally, in parallel. In the case of using liquid fuel type fuel cells such as a DMFC (direct methanol fuel cell) as power supplies for mobile equipment, it has been required to decrease the size of accessory machine such as a fuel feed pump and an air blower, or to eliminate the need of accessory machine. JP-A 2001-93551 discloses a fuel feed device being no need of power for such accessory machine by using a capillary attraction for feeding the liquid fuel to an anode.

The present invention is to provide a fuel cell being capable of feeding a liquid fuel to an anode without using for accessory machine such a power device while continuing power generation.

### SUMMARY OF THE INVENTION

The present invention provides a liquid type fuel cell comprising:

a fuel vessel with a fuel chamber section for retaining a liquid fuel and a fuel tank section for supply the fuel to said fuel chamber section;

a unit cell placed on said fuel chamber section so that the fuel is fed from said fuel chamber section;

a fuel transport member having first pores for retaining the fuel by a capillary attraction and second pores allowing the passage of a gas by not retaining the fuel, and the fuel transport placed in said fuel chamber section;

a fuel-gas exchange section provided between said fuel chamber section and said fuel tank section to lead the gas in said fuel chamber into said fuel tank section and to lead the fuel in said fuel tank section into said fuel chamber section; and

a vent hole provided to a wall of said fuel chamber section to exhaust the gas in said fuel chamber section.

The invention can provide a fuel cell capable of feeding a fuel to an anode without using accessory machine and capable of generating power continuously.

### DESCRIPTION OF THE ACCOMPANYING DRAWINGS

FIG. 1 is a schematic view of a fuel cell-power supply system according to the invention;

FIG. 2 is a perspective exploded view for a fuel cell module according to the invention;

FIG. 3 is across sectional plane view showing an embodiment of a fuel cell module according to the invention and its A-A′ line sectional view;

FIG. 4A is a cross sectional view and FIG. 4B;

FIG. 4B is an outer looking view of a fuel cell module according to the invention;

FIG. 5 is across sectional plane view showing an embodiment of a fuel cell according to the invention;

FIG. 6A is an outer looking plane view and its side view;

FIG. 6B is a cross sectional view of a fuel cell module according to the invention;

FIG. 7 is across-sectional plane view showing an embodiment of a fuel cell according to the invention, its A-A′ line sectional view, and its B-B′ line sectional view;

FIG. 8 is an enlarged view for a fuel-gas exchange section according to the invention; and

FIG. 9 is a conceptional view of a fuel capillary member according to the invention.

### DETAILED DESCRIPTION OF THE PREFERRED EMBODIMENT

Preferred embodiments of the present invention are to be described below but the invention is not restricted to the following embodiments.

In a fuel cell having methanol as a liquid fuel (hereinafter referred to as a DMFC: direct methanol fuel cell) used in this embodiment, electric power is generated in a way of directly converting a chemical energy possessed in the methanol into an electric energy by the electrochemical reaction shown below. On the side of an anode, an aqueous methanol solution fed takes place reaction in accordance with the following formula (1) and is dissociated into carbon dioxide gas, hydrogen ions, and electrons.

CH₃OH+H₂O→CO₂+6H⁺+6e⁻ formula (1)

Formed hydrogen ions move from the anode to a cathode through an electrolyte membrane and react with an oxygen gas on the cathode electrode. Here the reacted oxygen previously has reached on the cathode by diffusing from air. The hydrogen ions and oxygen on the cathode are reacted with each other in accordance with the following formula (2) to produce water.

6H⁺+3/2O₂+6e⁻→3H₂O formula (2)

Accordingly, in the entire chemical reaction upon power generation, methanol is oxidized with oxygen to form carbon dioxide gas and water as shown in the formula (3) and the chemical reaction scheme is identical with that of flame combustion of methanol.

CH₃OH+3/2O₂→CO₂+3H₂O formula (3)

As can be seen from the formula (1), carbon dioxide gas is produced at the anode of the unit cell. The carbon dioxide gas is dissolved in an aqueous methanol solution fed as a fuel just after the reaction of the formula (1). However, along with proceeding of the reaction, the amount of carbon dioxide gas exceeds an allowable level where the carbon dioxide gas can be dissolved into the aqueous methanol solution. As a result, carbon dioxide gas that can no more be dissolved completely in the aqueous methanol solution is produced as bubbles of carbon dioxide gas near the anode. Bubbles of carbon dioxide gas hinder fuel supply to the anode. Accordingly the fuel supply is stopped and the output of the fuel cell lowers, finally, electric power generation becomes impossible.

Hence, for continuous power generation in the fuel cell module, it is important to rapidly keep the bubbles of carbon dioxide gas away from the anode so that the fuel supply to the anode is not hindered.

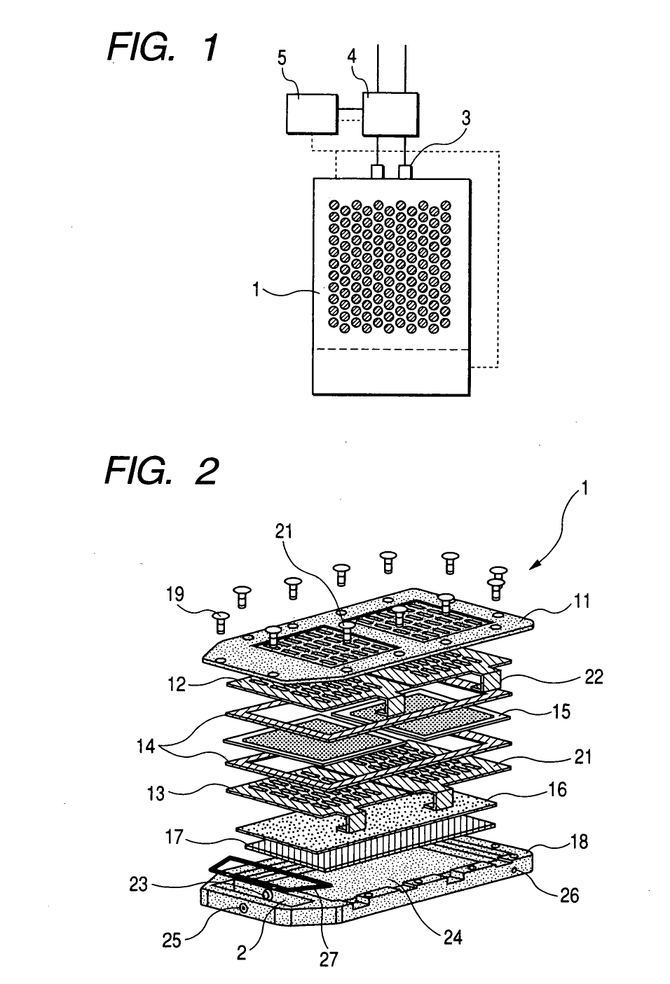

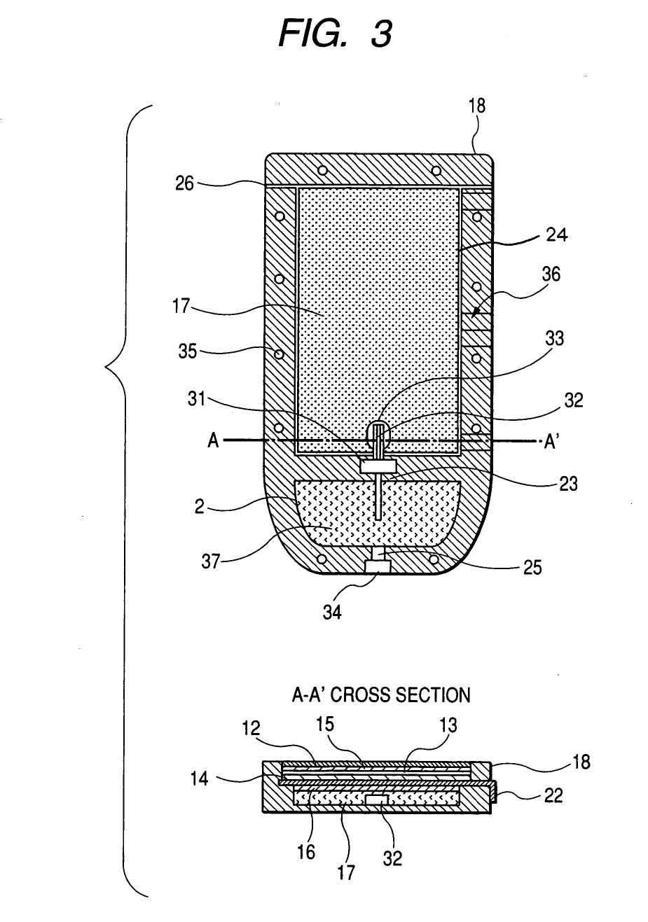

FIG. 1 shows a constitution of a fuel cell module as a power supply according to this embodiment. The fuel cell type power supply includes a fuel cell module 1, an output terminal 3, a DC/DC converter 4, and a controller 5. An out put of the fuel cell module 1 is supplied by way of the DC/DC converter 4 to an external load as electric equipment. The controller 5 takes in signals concerning the fuel residual amount in a fuel tank section 2 (refer to FIGS. 2 and 3) of the fuel cell 1 and situations during operation/stopping of the DC/DC converter 4, etc., and outputs warning signals as required. Further, the controller 5 can optionally display the power supply operation state such as a fuel cell voltage, a fuel cell output current, and a fuel cell temperature via an indicator of the external load. For example, when the residual amount in the fuel tank section becomes below a predetermined value or when the amount of air diffusion on the cathode deviates from a predetermined range, power supply from the DC/DC converter 4 to the load is stopped by controller 5; and abnormal information such as sounds, voices, pilot lamps or character display is issued by the indicator of the external load such. Also during normal operation, the fuel residual amount in the container can be displayed via indicator such as a display device of external load by receiving a fuel residual amount signal from the controller.

FIG. 2 shows the constitution for a fuel cell module by the exploded view. The fuel cell module 1 includes a cathode end plate 11 with slits 21 for feeding air under diffusion to a cathode, a cathode-current collector 12 with connector terminals 22, a gasket 14, plural MEAs 15 (Membrane Electrode Assembly) each constituting a unit cell, a gasket 14, an anode-current collector 13 with slits 21 for allowing the fuel to pass thorough, a fuel feed plate 16, a fuel transport member 17 and a fuel gasket 27. Those parts are layered in order listed above, and the layered structure is formed on the anode end plate 18.

The anode end plate 18 also serves as a fuel vessel and comprises a fuel chamber section 24 and a fuel tank section 2. The fuel chamber section 24 and a fuel tank section 2 are partitioned by a partition wall in the fuel vessel 18 (anode end plate). In each MEA, the cathode is placed on the upper side and the anode is palace on the lower side in FIG. 2. The cathode end plate 11 and the cathode-current collector 12 are provided slits 21 respectively. Those slits 21 are disposed so as to be aligned with each other, for air feeding by thermal diffusion. The ratio of opening of the slits 21 is preferably about from 30 to 50%.

The anode-current collector 13 is also provided with slits 21 such that the liquid fuel is fed and the diffusion by way of pores in the fuel feed plate 16. The ratio of opening of the slits 21 is also preferably about from 30 to 50%. In this structure, the anode end plate 18 constitutes, together with the cathode end plate 11, also a casing for the fuel cell. The casing of the fuel cell includes the fuel chamber 24 and the fuel tank section 2, and those two portions are partitioned to each other by a partition wall. The partition wall is provided with a fuel-gas exchange section 23. The outer wall portion of the fuel tank section 2 is provided with a fuel supply port 25. The fuel cell 1 is assembled by clamping the cathode end plate 11 and the anode end plate 18 with screws 19.

FIG. 3. shows a cross sectional plane view of the anode end plate 2 of containing other parts of the fuel cell and its A-A′ line sectional view. The partition wall between the fuel chamber 24 and the fuel tank section 2 is provides with a through hole 31. In this structure, a fuel-gas exchange section 23 for transporting the liquid fuel is placed in the through hole 31. A fuel transport wick 32 penetrates the fuel-gas exchange section 23. The fuel transport wick 32 is joined with the fuel transport member 17 through an auxiliary transport member 33. On the other hand, the fuel supply port 25 for adding the liquid fuel to the fuel tank section 2 is provided with the outer wall portion of the fuel tank section 2. The fuel supply port 25 is tightly closed with a cap 34 upon power generation of the fuel cell 1. Only when adding the fuel to the fuel tank section 2, the fuel supply port 25 is opened by detaching the cap 34 from the port. Further, in the inside of the fuel tank section 2, a fuel retainer 37 with a porosity of 75% or more is placed surrounding the fuel transport wick 32 for improvement of a fuel feed efficiency to the fuel cell. The relation for the capillary attraction of the fuel retainer 37, the fuel transport wick 32, the fuel transport member 17, and the anode of the MEA 4 is shown in the following formula (4):

P₇≦P₃≦P₁≦P_{A} formula (4)

Each of the capillary attractions is represented as P₇ for the fuel retainer 37, P₃ for the fuel transport wick 32, P₁ for the fuel transport member 17, and P_{A} for the anode, respectively. In the followings, identical symbols are used for the identical meanings in the formulae used for explanation of this embodiment.

By selecting the material and the average pore size (radius) for each of the parts so as to satisfy the formula (4), the liquid fuel supplied to the fuel tank section 2 is filled from the fuel retainer 37 to the fuel transport wick 32, the fuel transport member 17, and the anode successively by the capillary attraction. Thereby a continuous liquid fuel transport channel is formed from the fuel tank section 2 to the anode. When the liquid fuel is consumed by power generation on the anode, a negative pressure is generated in the continuous liquid fuel transport channel by a consumed volume, and the fuel in the fuel tank section is fed to the anode by the negative pressure as the driving force. On the other hand, since the inside of the fuel tank section 2 is in a sealed state under the capillary action, it becomes a negative pressure state along with the fuel feed to the anode. In this case, when the negative pressure in the inside of the fuel tank section 2 exceeds a pressure determined by the capillary attraction in the gap formed between the fuel-gas exchange section 23 and fuel transport wick 32, the gas in the fuel transport member 17 to be described later is sent by way of the fuel-gas exchange section to the inside of the fuel tank section 2. Thus, the negative pressure state inside the fuel tank section 2 is eliminated. As a result, the continuous fuel feed from the fuel tank section 2 to the anode is kept.

In a case where the continuous fuel feed is not kept sufficiently by only such a negative pressure eliminating mechanism, it is proposed to provide a gas-liquid separation membrane to the wall of the fuel tank section 2. For example, it is proposed to prepare the cap 34 equipped with a gas-liquid separation membrane.

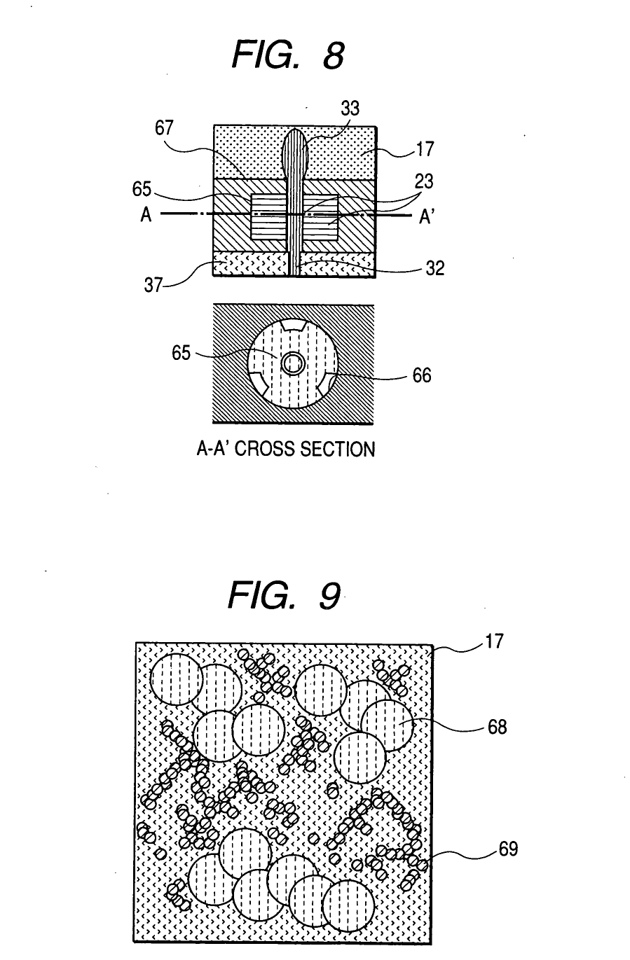

This embodiment shows an example of constituting the fuel-gas exchange section 23 as a collector type. The collector type fuel-gas exchange section 23 is to be described with reference to FIG. 8.

A partition wall 67 is provided with a collector fin-laminate structure that is constituted by plural collector fins 65 each spaced. The fuel-gas exchange section 23 is penetrated substantially at the center of the collector fin-laminate structure in the partition wall 67, Notches 66 are provided at the edge of the respective collector fins to constitute gas flow channel. A fuel transport wick 32 is penetrated the fuel gas exchange section 23 to connect the fuel chamber 24 and the fuel tank section 2.

When the pressure in the fuel tank section 2 becomes negative, a gas in the fuel chamber 24 flows into the fuel tank section 2 through the gas flow channel configured by the following spaces and notches, namely a space between the gas fuel transport wick 32 and the fuel-gas exchange section 23, a space between the collector fins 65 of the laminate structure, and the notches 66. As a result, the negative pressure in the fuel tank section 2 is eliminated, and the fuel from the tank section 2 is fed continuously to the fuel chamber 24.

Since laminated space constituted with the collector fins 65 forms a capillary tube and a buffer space, even when a pressure caused by impacts exerted on the fuel cell or an abrupt fluctuation in the external air pressure should result, it is possible to prevent abrupt flow-in or flow-out of the fuel between the fuel tank section 2 and the fuel chamber section 24. While an example of attaining the gas exchange function by the collector system is shown, this is not restrictive and any method may be adopted so long as it can adjust the internal pressure in the fuel tank section by introducing a gas from the outside depending on the change of the internal pressure in the fuel tank section. For example, it may be proposed to provide a groove for passing the gas from the fuel tank section 2 to the fuel chamber section 24 in the inside of the fuel-gas exchange section 23, or form a fine through hole in the partition wall separately from the fuel-gas exchange section 23 as a gas channel, without using the collector fins 65. In the cases described above, a structure insensitive a change of an external pressure can be obtained utilizing the capillary action by properly designing a cross sectional area of the groove or the through hole, and a clearance between the fuel-gas exchange section 23 and the fuel transport wick 32.

While the auxiliary transport member 33 is attached to the fuel transport wick 32 for feeding the fuel more smoothly, this can also be saved by properly designing a relation for the fuel transport member 17, the fuel transport wick 32, and the fuel retainer 37 in accordance the formula (1) described above.

Further, also the fuel retainer 37 is not always necessary. In this case, fuel leakage can be prevented when capillary attraction P₄ of the gas flow channel satisfies the following relation:

P₃>P₄>>Pₒ+ρgh

in which Pₒ represents a pressure applied from the outside such as impact, ρ represents the density of the liquid fuel, g represents the gravitational acceleration, and h represents the head difference of the liquid fuel retained in the porous member.

The anode end plate 18 is provided with connector terminal-holes 36 for leading connector terminals 22, which are attached to the cathode-current collector 12 and the anode-current collector 13, to the outside. A plurality of MEAs 15 disposed within the same plane are connected in serial at the side wall of the anode end plate 18. The gaskets 14 are structured so as to sandwich the MEAs 15 and tightly be in contact with a periphery (no slits 21 area) of the cathode current collector 12 and the anode-current collector 13, for sealing between both the current collectors. Thereby, the gaskets prevent the liquid fuel to be fed to the fuel transport member 17 from leaking at the anode end plate 18.

Further, a plurality of pinholes 26 are provided at a side wall of the fuel transport member 17-containing portion in the anode end plate 18. The pinholes 26 have a function for exhausting carbon dioxide gas produced along with power generation at the anode. That is, the carbon dioxide gas produced along with power generation is led to the inside of the anode end plate 18 through pores 68 provided in the fuel transport member 17 (the pores 68 is described latter by using FIG. 9), after that, it is exhausted through the pinholes 26. The diameter of each pinhole 26 is set at such a small pore size that a differential pressure along with exhaust of the carbon dioxide gas little occurs and that air intrusion by diffusion from the outside of the module little occurs. While a size of each pinhole 26 are defined as 1 mm in the fuel cell of this embodiment, so long as it is 1 mm or less, lowering of the anode performance due to diffusive intrusion of air is not substantially observed and the internal pressure near the anode is neither increased.

The characteristic of the fuel transport member 17 used in this embodiment is to be described specifically hereinafter.

In the inside of the fuel chamber section 24, it is necessary to simultaneously attain the feed of the liquid fuel to the anode and exhaust of carbon dioxide gas produced at the anode along with power generation. Accordingly, the basic structure of the fuel transport member 17 is proposed as a dual structure comprising: a first pores with capillary attraction capable of transporting the fuel; and a second pores having no clogging of a surface tension of the fuel liquid to exhaust a gas produced at the anode. Such a second pores is constituted by the following pores, namely for example, pores with relatively large diameter having no clogging of the surface tension of the liquid fuel; or pores with a water repellency. Further, in stead of the above-mentioned first pores and second pores, a first pores may be constituted with hydrophilic pores, and a second pores may be constituted by water repellency pores.

With accordance to such a configuration, the gas phase produced at the anode can be exhausted from the pinholes 26 to the outside of the cell module through the relatively large diameter pores or water repellency pores in the fuel transport member 17. That is, the gas exhausted channel-pores was constituted by the second pores. On the other hand, the liquid fuel from the fuel tank section 2 is transported from the fuel chamber section 24 to the anode through the relatively small diameter pores (namely pores with a capillary attraction) or hydrophilic continuous pores. The average diameter of the second pores is defined to a size of having a small or little capillary action so as not to be filled with the liquid fuel. The design for reduction of thickness of the fuel transport member 17 is restricted upon such a pore's diameter condition. In view of the design of the transport member 17, for attaining the thickness reduction thereof, it is effective to render the inner wall of the second pores (gas exhaust channel-pores) as water repellency. Such water repellency also enables the diameter of the gas exhaust channel-pores to further reduce. Thus the thickness of the fuel transport member 17 can be reduced, and a volume fraction of the exhaust gas channel relative to the fuel transport member 17 can be decreased. Thereby, a filling factor of the liquid fuel becomes higher, so that a fuel cell with high energy density can be obtained.

The material used for the fuel transport member 17 has no particular restriction so long as the material has a stable strength as a structural body, corrosion resistance under the circumstance of using the cell, and has no ingredients leaching to the aqueous methanol solution. For example Natural fiber materials such as pulp, porous materials comprising polymers, etc., porous materials comprising synthetic fibers, porous materials comprising ceramics or metals, etc. can be used for the fuel transport member 17. Particularly, high-stiffness porous materials of ceramics, intermetallic compounds or metals, or specified elasticity-porous metal materials are suitable materials. In the fuel cell of laminating its components, the fuel transport member 17 made of the elasticity materials can be pressurized uniformly over the entire surface of the MEA 15 for long time stably. As a result, the internal resistance of the fuel cell power supply can be lowered and the output of the power supply can be improved.

FIG. 9 is a conceptional view of the fuel transport member 17 having the above-mentioned features.

The fuel transport member 17 includes a first pores 69 having relatively a smaller average pore size and a second pores 68 having relatively a large average pore size. The first pores 69 are capable of retaining and transporting the liquid fuel by the capillary attraction. The average diameter of the second pores 68 is defined to a size of having a small or little capillary action so as not to be capable of retaining the liquid fuel. The first pore serves 69 as a fuel transport channel, and the second pore 68 serves as a gas transport channel. The relation of those capillary attractions can be represented qualitatively as in the following formula (5).

P₁<Pₒ+ρgh<<P₂ formula (5)

in which P₁ represents an average capillary attraction of the first pores 69, P₂ represents an average capillary attraction of the second pores 68, Pₒ represents a pressure applied from the outside such as impact, ρ represents the density of the liquid fuel, g represents the gravitational acceleration, and h represents the head difference of a liquid fuel retained in the porous material.

Generally, the capillary attraction can be represented as: P=2s cos θ/r, assuming r as the pore size of the capillary, s as the surface tension of liquid, θ as a contact angle contact between the material of the capillary tube and the liquid.

Accordingly, the relation of the respective average pore diameters between the first pores and the second pores can be represented by the following formula (6):

2s cos θ₁/r₁<Pₒ+ρgh <<2s cos θ₂/r₂ formula (6)

in which r₁ and r₂ represent the respective average pore diameters of the first and the second pores, s represents the boundary tension of an aqueous methanol solution, and θ₁ and θ₂ represent the respective contact angles between the aqueous methanol solution and the material of the fuel transport member 17. θ₁ and θ₂ are values equal with each other in this case.

Further, in order not to leak the fuel from the pinholes 26 by the impacts or fluctuation of the external air pressure, the condition on the pinhole sizes r₆ is as shown by the following formula (7) that is, it may be selected preferably so as to satisfy:

2s cos θ₁/r₁<2s cos θ₆/r₆<Pₒ+ρgh formula (7)

Concerning the pinholes 26, the reason of defining the lower limit thereof is to intend to prevent the pinhole 26 from being filled with the fuel. In other words, if the pinhole 26 has a larger capillary attraction than the first pore, the pinhole 26 is filled with the fuel.

In the fuel transport member 17, the first pores 69 chains with each other and the second pores 68 also chains with each other, while overlapping with each other. In FIG. 9 showing a cross section for the fuel transport member, the first pores 69 and the second pores 69 respectively chains only partially but each of the pores further chains with the same type of other pores not shown in FIG. 9 in view of the three-dimensional manner. Thus, the liquid fuel is retained and transported by the first pores 69; on the other hand, the second pores 68 serve as a relief channel through which carbon dioxide gas produced at the anode release outside of the fuel cell module.

Since the fuel is not filled in the second pores 68, the more the volume of the second pores, the lower the energy density of the fuel chamber section 24. In contrast with this, the less the volume of the second pores, the likelier it becomes hard to release the carbon dioxide gas. Accordingly, it becomes a necessity for the second pores to design optimally. For example, the following way for an optimum design of the second pores is suggested. In advance of forming the second pores, forming the first pore in the fuel transport member 17, and then forming a plurality of grooves corresponding to the second pores on the surface of the fuel transport member 17 or forming through holes to be the second pores in the fuel transport member 17. Thus the location and the cross sectional area of the second pores can be designed by adjusting them easily.

The gases in the fuel transport member 17 include carbon dioxide gas produced at the anode and air flowing into the fuel chamber section 24 from the pinhole 26 by diffusion.

Further, the attachment of a water repellency porous membrane to the pinhole is an effective means for executing a gas-liquid separation while sealing the pinhole 26, thereby releasing only gases to the outside of the fuel cell and then preventing the liquid leakage from the pinhole.

The anode of this embodiment generally comprises pores of 1 to 50 μm radius formed with secondary carbon particles and pores formed with primary particles of several tens nm radius. Under constraints of the average pore radius in the anode described above, the average radius of the first pores 69 for fuel transport of the fuel transport member 17 are set to from 50 to 250 μm in average. On the other hand, the second pores 68 for the gas transport preferably has a pore size of 500 μm or more radius in average so as to have no clogging of the surface tension of the liquid fuel. It will be apparent that such a pore size is not uniquely defined but selected in view of the relation with respect to a contact angle between the fuel transport member and the liquid fuel, and the viscosity of the liquid fuel. Particularly, in a case of supporting high water repellency fine particles such as polytetrafluoro ethylene on the inner walls of the gas transport pores (second pores 68), or of coating such a water repellency material on the inner walls of the same, the fuel transport member 17 can be configured by a structure where the average radius of the gas transport pores is smaller than that of non-supporting or non-coating of the water repellency material.

While the pore shape of the porous material can be observed under a scanning electron microscope, the pores often have indefinite shape.

The pore size of each pore defined, for example, as a value obtained by the following manner: namely steps of obtaining a surface photograph of a porous material by scanning electron microscope, integrating an area of a pore portion in the surface photograph by way of image processing, replacing the integrated value with a circle of an identical area, and defining a diameter of the circle as the pore size. The average pore size is defined as an average value of pores' sizes. However, since the surface observation by the scanning electron microscope is sometimes difficult to be applied to insulative materials, another manner is sometimes adopted for the insulative material, as follows. That is, by filling a conductive resin into the pores by injection with pressure, observing the conductive resin by using a scanning electron microscope, and then obtaining the cross sectional area of the resulting pore.

Further, for defining the average value of the pore size, it can be determined by taking cross sectional scanning electron microscope photographs in various directions and measuring the pore size distribution within the photographed plane.

The fuel transport wick 32 has a function for transporting the fuel from the fuel tank section 2 to the fuel transport member 17 by way of the fuel-gas exchange section 23. The transport wick 32 is not particularly of limited material so long as having a stable strength as a structure, having corrosion resistance under the circumstance of cell operation, and having no ingredients apt to leach the aqueous methanol solution. For example, natural fibers such as pulp, porous materials comprising polymers, etc., porous materials comprising synthetic fibers, porous materials comprising ceramics or metals can be used. Among all, for coping with various structures, flexible materials formed by bundling single yarns of polyethylene, polypropylene, polyester, and polyethylene terephthalate, porous materials comprising twisted yarns of natural fibers such as cellulose, for example, cotton yarns or twisted yarns of synthetic fibers such as of nylon, tetron, polyethylene, polypropylene, acrylic, polyurethane, polyphenylene, polyester, and polyethylene terephthalate, or foaming polymer materials having continuous pores, for example, polyurethane can be said to be preferred materials. The fuel transport wick 32 having a function of the fuel-gas exchange section 23 is designed and manufactured within a range of the pore size from 50 to 500 μm in average. In a case where the pore size is less than 50 μm, it may be disadvantageous since the difference with the diameter of the anode pore is small, the wicking force for the liquid fuel along with fuel consumption is small and the transport resistance increases. In a case of being more than At 500 μm, it is difficult to retain the liquid fuel continuously in the pore, which causes liquid leakage and makes the fuel transport impossible. Also in this case, it will be apparent that the pore size is not defined primarily but selected in view of the relation with the angle of contact between the wick material used and the liquid fuel, or the viscosity of the liquid fuel.

The fuel retainer 37 with a relatively large porosity is filled surrounding the fuel transport wick 32 in the fuel tank section 2. This is filled for effectively using the filled fuel in the fuel tank section 2 completely. While there is no particular restriction on the filling ratio, higher energy density can be attained for the fuel cell as the porosity is larger so long as the liquid fuel can be retained and fed to the fuel transport wick 32. The material used herein is not particularly restricted so long as the material has the corrosion resistance under the circumstance of cell operation and has no ingredients leaching to the aqueous methanol solution. For example, natural fibers such as pulp, porous materials comprising polymers, etc., porous materials comprising synthetic fibers, porous materials comprising ceramics or metals can be used. Among all, for coping with various structures, flexible materials formed by bundling single yarns of polyethylene, polypropylene, polyester, and polyethylene terephthalate, porous materials comprising twisted yarns of natural fibers such as cellulose, for example, cotton yarns or twisted yarns of synthetic fibers such as of nylon, tetron, polyethylene, polypropylene, acrylic, polyurethane, polyphenylene, polyester, and polyethylene terephthalate, or foaming polymer materials having continuous pores, for example, polyurethane can be said to be preferred materials.

As described above, the fuel feed system of the fuel cell in this embodiment has a feature in that a fuel transport channel is formed by the combination of a plurality of porous members, and the fuel is transported stably by the capillary negative pressure generated by fuel consumption at the anode upon power generation.

Joint of different porous members makes the liquid migration resistance increases at the joined surface between them. In this embodiment, for an aim of decreasing the liquid migration resistance particularly at the joining portion between the fuel transport wick 32 and the fuel transport member 17, it is effective to interpose the following auxiliary transport member 33 a fibrous porous material with excellent flexibility such as cellulose, polyethylene, polypropylene, polyester, polyurethane and polyethylene terephthalate, or a sponge porous material made of polymeric material.

The material used for the cathode end plate 11 and the anode end plate 18 for the fuel cell is not particularly restricted so long as the material has a substantially insulative property, a strength capable of supporting the cell structure, and a corrosion resistance under an operation circumstance. Especially high density vinyl chloride, high density polyethylene, high density polypropylene, epoxy resin, polyether ether ketones, polyether sulfones, polycarbonates or glass fiber reinforced products thereof may be used preferably. Alternatively, it may also use carbon plate, steel, nickel and other light weight metal and alloy materials such as titanium, aluminum, magnesium, or inter-metallic compounds typically represented by copper-aluminum, or various kinds of stainless steels, by rendering the surface not conductive, or by coating a resin to render the surface insulative.

As shown in FIG. 2 as an example showing the stacked structure of a fuel cell, both gaskets 14 sandwich a rim of the electrolyte membrane of the MEA 15 to ensure sealing between the anode and the cathode. The material of the gaskets is not particularly restricted so long as the material is electrochemically stable, and has no substantial solubility and swelling property to methanol. Known gasket materials such as sheets of synthesis rubber, for example, ethylene propylene rubber, and fluoro rubber and various kinds of liquid sealant materials are used. Particularly, a butyl rubber type hot melting sheet having a hot melting property can maintain high planarity and has a characteristic of fusing at a temperature not damaging the electrolyte membrane or the like, and it can be said to be a preferred material.

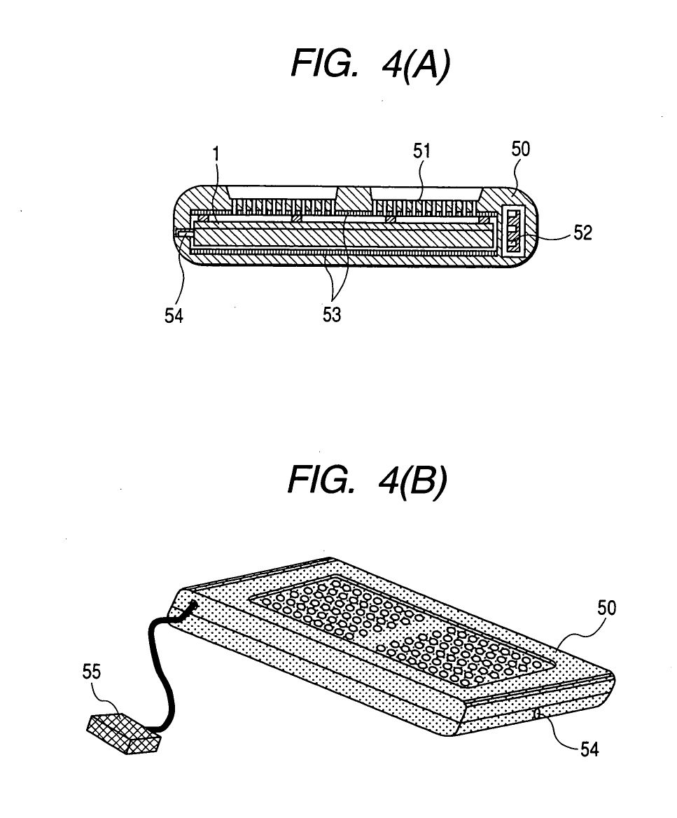

FIG. 4A shows a cross sectional view of a mounting example of a mobile battery charger 50 using a direct methanol fuel cell with a maximum output power of 2 W and an average power of about 1 W. In the battery charger 50, a fuel cell 1, a converter/controller 52, and a moisture absorbing and rapidly drying material 53 are installed in a casing. The casing has a structure in which a fuel cell housing section and a converter/controller 52 board housing section are isolated by a partition wall respectively, so that electronic parts of the converter/controller are not in contact with the fuel cell exhaust gas.

In the fuel cell housing section of the battery charger casing, its one side f acing the cathode end plate is provided with a plurality of slits or holes to be an air intake port 51. The moisture absorbing and rapidly drying member 53 has a function of rapidly absorbing water of condensation formed upon overload operation of the fuel cell or upon abrupt lowering of an external air temperature, and of spreading the same for a wide area for rapid evaporation. The member 53 is attached to the inner wall surf ace of the casing of a fuel cell housing section. It has a structure in which slits or holes aligned with the hole-pattern for the air inlet port of the casing is formed particularly on the surface facing the cathode. Further, a fuel inlet port 54 is disposed at a position corresponding to the fuel inlet port 25 of the fuel cell.

FIG. 4B shows an appearance of the battery charger 50 according to this embodiment. The battery charger has an output connector 55 in common with mobile equipment and by connecting the connector with equipment, a secondary battery incorporated in the equipment can be charged, or it can be connected directly with the load.

While an example of applying the mobile DMFC as the battery charger is shown, the invention is not restricted to such an example but it is also usable in the form incorporated, for example, in a mobile telephone or individual information terminal, mobile audio-equipment, etc.

An aqueous methanol solution as a fuel at a predetermined concentration is filled in the fuel tank section 2. The method of feeding the liquid fuel into the fuel tank section 2 is not particularly restricted. It can be directly fed by using a syringe or a dropper. Furthermore, a method of using a cartridge type fuel tank with a known sealed connector structure to the fuel inlet port 25 is also an effective method in view of preventing liquid leakage and ensuring the safety. The concentration of the fuel differs depending on the property of the electrolyte membrane used. That is, an aqueous methanol solution can be used at a relatively low concentration for a perfluoro carbon type membrane with large methanol crossover as typically represented by Naphion (manufactured by DuPont Co.). Alternatively, the aqueous methanol solution can be used at a relatively high concentration for a hydrocarbon type sulfonic acid membrane. Generally, in the method of directly feeding the liquid fuel, a 3 to 10 wt % aqueous methanol solution can be used for the perfluoro carbon type electrolyte membrane. Alternatively, a 10 to 40 wt % aqueous methanol solution can be used for the hydrocarbon type electrolyte membrane.

When adopting the fuel feed system using the capillary attraction of the fuel transport member according to this embodiment, since substantial lowering of the contact ratio of the liquid fuel to the anode is caused, substantial crossover amount of methanol and water can be decreased. Accordingly, compared with a case of feeding the liquid fuel directly, the cell can work without virtually causing heat generation on the cathode, flooding of the cathode, and lowering of the cell performance based on the crossover even when the cell works at a high fuel concentration. For example, when using the perfluorocarbon type electrolyte membrane, stable fuel cell working can be attained even when the concentration is increased up to 25 wt % at the maximum. Alternatively, when using the hydrocarbon type electrolyte membrane, stable fuel cell working can be attained even when the concentration is increased up to 40 wt % as the maximum. As a matter of fact, when using an electrolyte membrane of further lower crossover, the fuel cell is capable of working at further higher concentration. The invention has an advantage capable of increasing the ratio of utilizing the fuel, enabling the fuel cell working at higher fuel concentration, thereby increasing the energy density of the fuel used, and increasing the energy density of the power supply per one shot of fuel fill, that is, remarkable extending the power generation continuing time.

In the capillary transport according to this embodiment, the fuel transport speed and the liquid leakage preventive effect are determined depending on the characteristic such as the material constituting the capillary tube or pore size. But since the surface tension fuel, the solid-liquid contact angle, and the liquid viscosity, etc. of the fuel are varied depending on the methanol concentration, so that the transport speed of the capillary transport material, the liquid leakage preventive effect, etc may be changed. Accordingly, for ensuring the compatibility with fuels of different concentrations, it is an effective method of adding an electrochemically inert substance to a liquid fuel to controlling the solid-liquid contact angle, viscosity, etc. The electrochemically inert substances are exampled preferably as at least one of: higher alcohols such as ethylene glycol, heptanol, and octanol; saccharides such as ribose, deoxyribose, glucose, fructose, galactose, and sorbitol; and cellulose ethers such as methyl cellulose, ethylene cellulose, and carboxymethyl cellulose, as well as agar and gelatin. The addition amount thereof is selected depending on the predetermined liquid viscosity and, generally, it is preferably about from 0.1 to 1 mol %. Since the aqueous methanol solution with addition of the substance described above can be controlled to a desired viscosity and can increase the osmotic pressure of the liquid fuel, it can decrease the crossover of water and methanol and improve the fuel utilization ratio as a secondary effect.

Embodiments for carrying out the invention has been described above and several examples characteristic to the invention are to be described more specifically.

### Embodiment 1

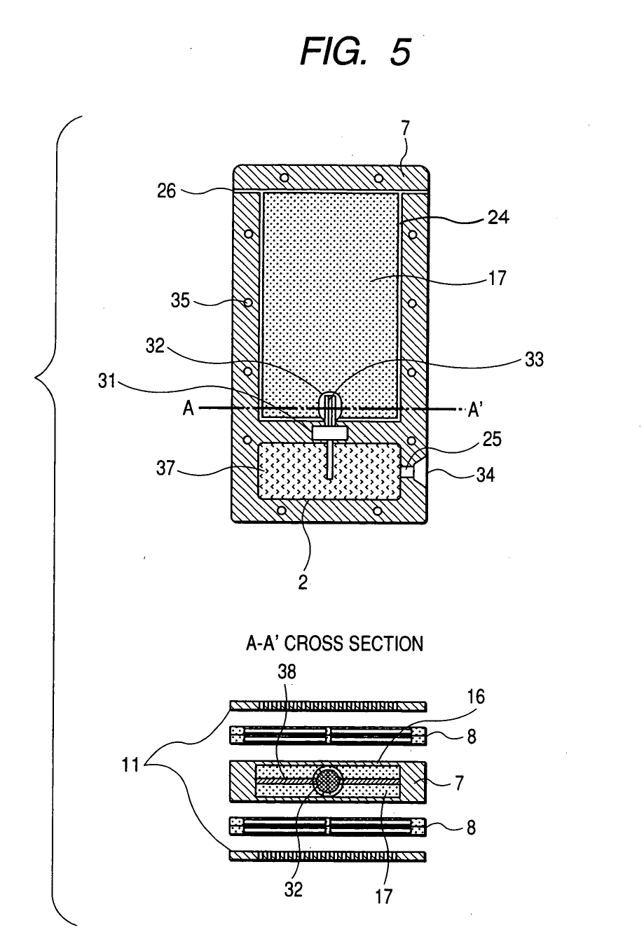

FIG. 5 shows an outline, a longitudinal cross sectional view and a transverse cross sectional exploded view of a fuel cell power supply. A fuel cell 1 includes a fuel chamber frame 7, a power generation device 8 formed by stacking MEA, a diffusion layer, a collector plate, and a cathode end plate 11, in which the power generation devices 8 are arranged on both surfaces of the fuel chamber frame.

A porous metal fuel transport member 17 is contained in the inside of the fuel chamber frame 7. The fuel chamber frame 7 is integrally provided with a fuel tank section 2 and a collector type fuel-gas exchange section 23. One end side of a fuel transport wick 32 is joined to the fuel transport member 17 by way of an auxiliary transport member 33, and another end side thereof is joined to the fuel retainer 37 filled in the fuel tank section 2. Thereby a capillary-fuel passage is formed. In this structure, polyester fibers are used for the fuel transport wick 32 and the fibers are used as a bundled structure while selecting the fiber diameter to about 180 μm so that the average pore size of the fuel transport wick 32 was about 180 μm. The fuel retainer 37 was filled in the fuel tank section 2 such that the porosity of the polyester fibers becomes about 80 vol %. Since the power generation devices 8 were arranged on both surfaces of the fuel chamber frame 7 while sandwiching the frame therebetween, a liquid short circuit preventive plate 38 for preventing the liquid short circuit between opposed MEAs is put between two fuel transport members 17. In addition, a fuel feed plate 16 is used for preventing electric short circuit between the adjoining MEAs of stacked single cells. The fuel feed plate 16 was arranged to the outer surface of the fuel transport member 17.

It is preferred that the capillary attraction of the pore of the fuel feed plate 16 is larger than that of the first pore of the fuel transport member 17 and smaller than that of the anode. This is because the fuel feed plate 16 serves as a fuel feed means for feeding the fuel from the fuel transport member 17 to the anode. Further, while the fuel feed plate 16 is necessary in this embodiment since the fuel transport member 17 was made of the porous metal, the fuel feed plate is not always necessary in a case of using an insulator such as ceramics for the fuel transport member 17.

However, if oxygen intruded under diffusion from the pinhole 26 reaches through the second pore to the vicinity of the anode, the cell power is sometimes lowered. In such a case, it is effective to use the porous fuel feed plate even when using the insulator for the fuel transport member 17. This is because the fuel is filled in the pores of the fuel feed plate and serves as a liquid seal.

The more reduction of the fuel feed plate 16 thickness, the more the effect of the fuel transport member 17 in this embodiment can be attained. However, the thickness of the fuel feed plate 17 has to be decided in consideration of not causing deterioration of the insulative function.

As a preferred thickness of the fuel feed plate 16, it is preferably less than the diameter of bubbles of carbon dioxide produced in the vicinity of the anode. This is because such bubbles of carbon dioxide immediately after being produced directly reach the second pores (shown in FIG. 9) of the fuel transport member 17, and are discharged rapidly from the vicinity of the anode.

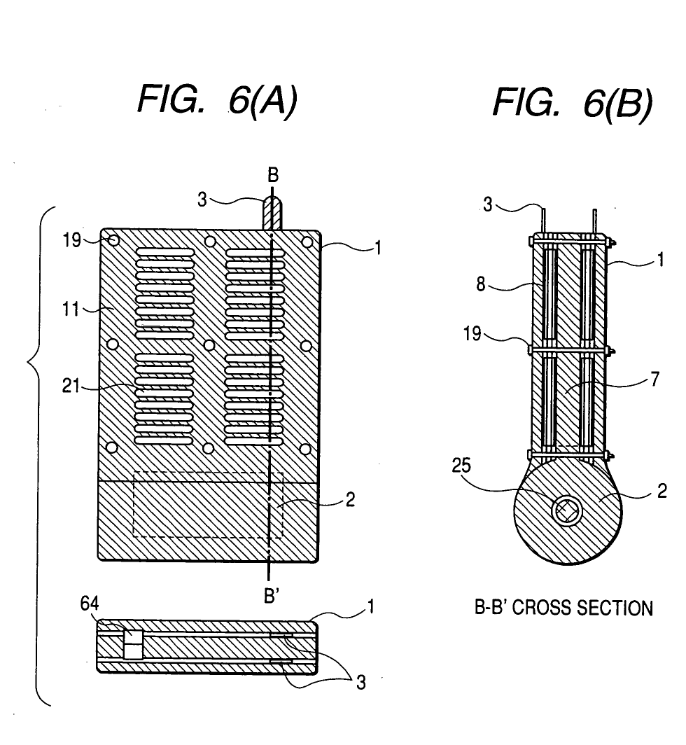

Another feature of this embodiment is that the thickness of the fuel tank section 2 is made larger than the thickness of the fuel cell as shown in FIG. 6. Thus, even when the fuel cell is placed on a floor, it can ensure to keep space between the floor and a fuel cell-one side surface facing the floor. Accordingly, the power generation device 8 can take in air from both side surfaces thereof so that the air can be diffused into the device 8 sufficiently. Structures other than the above-mentioned feature are basically identical with those in Embodiment 1, but a fuel supply port 25 is formed along the axial line of the fuel tank section 2.

A method of producing a metal-fuel transport member 17 is to be described. The method comprises steps of preparing fine powder of SUS 316L of an average grain size of 100 μm pulverized by a water-atomizing method, a solid of paraffin wax with an average grain size of 1000 μm, and commercially available methyl cellulose, and mixing and kneading them. The kneaded product is molded into a plate shape and dried at 50° C. The molded product is washed with a solvent so that the paraffin wax particles in the molded product are dissolved and extracted. After drying at 90° C., it is degreased in a nitrogen atmosphere at 600° C. for one hour and, further sintered in vacuum at 1200° C. to prepare a fuel transport member made of SUS 316L. As a result of a usual pore distribution evaluation method and scanning electron microscopic measurement, the obtained metal-fuel transport member comprises a porous material having two types of distributions with the pore size of 50 μm and the pore size of 850 μm mainly.

The fuel transport member 17 using the SUS 316L porous metal is a resilient material having an elasticity limit at about 15 kg/cm², and designed such that it is compressed by about 50 μm when all of the cell components are fixed with screwing. Each of the cell members undergoes a pressure of about 5 kgf/cm² by the reaction force thereof to ensure a constant pressure even when some creep deformation is caused to a portion of the cell components.

In this embodiment, the power generation devices 8 comprises a plurality of MEAs arranged within each identical plane, and the MEAs are electrically connected to one another in series. The device 8 has a cell structure of sandwiching the porous resilient-fuel transport member 17 having two kinds of pores of different sizes. The porous fuel transport member 17 is joined with the fuel transport wick 32 to constitute a fuel-gas exchange section having a collector structure. The fuel chamber section 24 and the fuel tank section 2 are combined by way of the fuel-gas exchange section 23. Accordingly, a liquid transport channel comprising the capillary tube is formed from the fuel tank to the anode. Thus, the liquid fuel is transported by the negative pressure in the capillary caused by fuel consumption on the anode. The fuel transport in this case is ensured continuously by letting the gas in the fuel chamber section 24 escape into the fuel tank section 2 through the fuel-gas exchange section. Further, carbon dioxide gas produced on the anode is separated from the fuel and discharged to the outside of the cell through the second pores 68 (refer to FIG. 9; it is not filled with the liquid fuel) of the fuel transport member and the pinhole of the fuel chamber frame. According to this structure, since gas-liquid separation is carried out by the second pores of the fuel transport member 17 in the fuel chamber section 24, there is no need to prepare any special gas-liquid separation mechanism such as a porous membrane structure.

The fuel transport channel of this embodiment is designed and arranged from the fuel tank section to the electrode as follows. That is, the fuel trans port wick 32 lying across the fuel tank section 2 and the fuel chamber section 24 has each pore of about 180 μm in average, the fuel transport member 17 has each pore (first pore 69 referred to FIG. 9) of 50 μm in average, and the anode electrode has each pore of about 20 μm in average. In other words, the pore sizes of fuel transport channel are decreased in stage from the fuel tank section toward the electrode. On the other hand, each second pore 68 of the fuel transport member 17 is 850 μm radius in average. Since the pore size does not make capillary action to a 30 wt % aqueous methanol solution, such a methanol solution does not clog the second pore. Therefore the gas produced at the anode is discharged therethrough from the exhaust pinhole 26. Accordingly, even when the fuel cell changes its attitude, the transport channel of the fuel liquid can keep up the its function and, further, even when the fuel cell is shaken strongly being gripped by a hand, the methanol fuel does not leak from the liquid retaining capillary tube. This shows that the fuel cell can work stably at any attitude.

Further, according to the embodiment, neither restriction for the attitude nor the conventional type gas-liquid separation mechanism is necessary. Since gas-liquid separation of the embodiment is conducted by providing two kinds of pores, the exhaust port cross sectional area for exhausting the resultant gas can be made sufficiently small as about 2 mm² or less compared with the case of the conventional gas-liquid separation membrane mechanism requiring an area of 1 cm² or more. Accordingly, it can prevent wasteful evaporation of the fuel and can decrease the diffusion of air to the fuel chamber section, so that a system of high fuel utilization rate can be attained.

The size of the power supply in the embodiment was 115 mm×90 mm×9 mm and, when a power generation test was conducted at a room temperature by injecting a 30 wt % aqueous methanol solution to the fuel tank section, and the power was 2.4 V, 0.8 W.

### Embodiment 2

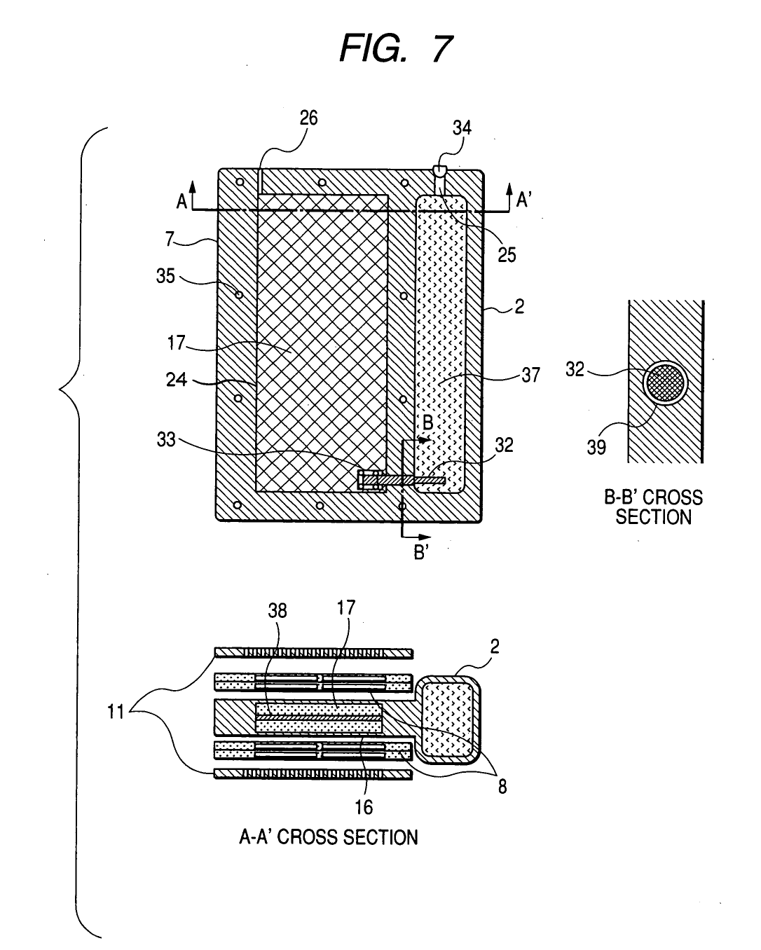

As shown in FIG. 7, a fuel cell 1 according to an Embodiment 2 includes a fuel chamber frame 7, power generation devices 8 arranged on both surfaces thereof and a cathode end plate 11 like Embodiment 1. A porous metal fuel transport member 17 is placed in the inside of the fuel chamber frame 7. For example, the fuel cell 1 has a structure in which twelve MEAs 15 like FIG. 2 are arranged on both sides of the fuel chamber section and connected in series. A remarkable difference from Embodiment 1 is in a structure of the fuel tank section 2 integrated with the fuel chamber section 24 on the side thereof. FIG. 7 shows a layout for each of parts in the fuel chamber frame 7 and a cross sectional structure thereof. A fuel transport wick 32 is disposed to the partition wall between the fuel chamber frame 7 and the fuel tank section 2 through a porous fuel-gas exchange section 39. The porous fuel-gas exchange section 39 has a function of introducing a gas in the fuel chamber under a predetermined condition into the fuel tank section. The fuel transport wick 32 is joined to the fuel transport member 17 at one side thereof through an auxiliary transport member 33 and to a fuel retainer 37 at the other side. The fuel chamber frame 7 is provided with a pinhole 26 for exhausting a gas produced at the inside of the fuel chamber frame 7. Since the power generation device 8 are arranged on both surfaces of the fuel chamber frame 7 while sandwiching the frame therebetween, a liquid short circuit preventive plate 38 for preventing liquid short-circuit between opposed MEAs is put between two fuel transport members 17. In addition, a fuel feed plate 16 is used for preventing electric short circuit between the adjoining MEAs of stacked single cells. The fuel feed plate 16 was arranged to the outer surface of the fuel transport member 17. The fuel chamber frame 7 in which such members are laid out, the power generation devices 8, and the cathode end plates 11 are stacked as shown in the cross sectional view along A-A′ in FIG. 7 and assembled integrally with screws to constitute a fuel cell.

The fuel transport member 17 in this embodiment uses the same porous material of SUS 316L as that in Embodiment 1. The power generation devices 8 comprises six MEAs 15 (refer to FIG. 1) that are connected in series within each plane in the same method as in Example 1. The MEAs 15 are sandwiched by current collectors 12, 13 (refer to FIG. 1). Resin films constituting current collectors, the anode diffusion layer and the cathode diffusion layer of each MEA are identical with those used in Example 1.

Polyester fibers are used for the fuel transport wick 32, the fuel retainer 37, and the porous gas exchange section 39. The average fiber pore size of the porous transport wick 32 is about 180 μm, and the average fiber pore size of the porous gas exchange section 39 was about 200 μm. Their fibers are bundled respectively. For the fuel retainer 37, polyester fibers are filled and used in the fuel tank section 2 such that the porosity is about 80 vol %.

In the fuel cell of this embodiment, the average pore size of the anode is about 20 μm, the average pore size of the fuel transport member 17 is about 50 μm, and the average pore size of the fuel transport wick 32 and a fuel transport wick used for the fuel cartridge is 180 μm; and they are arranged in this order so that the continuous fuel transport channel with the capillary attraction can be formed easily. Further, the average radius of the large diameter pore for exhausting the gas phase in the fuel chamber is about 850 μm in average, and it is not clogged by the wicking of the liquid fuel.

The power supply of the embodiment showed no substantial lowering in the power supply voltage by preventing liquid short-circuit between the MEAs due to ionic materials in the fuel chamber. In a structure of leading out the voltage terminal from each MEA, the voltage for MEA is generally within a range from 0.33+0.02. It could be confirmed that the cell according to this embodiment did not allow the power to vary at any attitude when gripped by the hand. Also power generation can be continued with no leakage of the liquid fuel even when the cell was shaken by the hand.

The power supply size of this example was 120 mm×100 mm×15 mm and, when a fuel cartridge filled with a 30% wt % aqueous methanol solution is mounted, and put to a power generation test at a room temperature, the power was 4.0 V, 1.28 W.

What is claimed is:

1. A fuel cell comprising:
a fuel vessel with a fuel chamber section for retaining a liquid fuel and a fuel tank section for supply the fuel to said fuel chamber section;
a unit cell placed on said fuel chamber section so that the fuel is fed from said fuel chamber section;
a fuel transport member having first pores for retaining the fuel by a capillary attraction and second pores allowing the passage of a gas by not retaining the fuel, and the fuel transport placed in said fuel chamber section;
a fuel-gas exchange section provided between said fuel chamber section and said fuel tank section to lead the gas in said fuel chamber into said fuel tank section and to lead the fuel in said fuel tank section into said fuel chamber section; and
a vent hole provided to a wall of said fuel chamber section to exhaust the gas in said fuel chamber section.

2. The fuel cell according to claim 1, wherein said fuel-gas exchange section has a fuel transport wick and a gas flow channel satisfying the following relation:
P₂<Pₒ+ρgh<P₄<P₃≦P₁
in which P₁ represents a capillary attraction of said first pore, P₂ represents a capillary attraction of said second pore, P₃ represents a capillary attraction of a pore of the fuel transport wick, P₄ is a capillary attraction of said gas flow channel, Pₒ represents a force applied from the outside, p represents density of the fuel, g represents gravitational acceleration, and h represents a maximum head difference in said fuel tank section when said fuel tank is tilted.

3. The fuel cell according to claim 1, wherein a porous fuel retainer is placed in the fuel tank; said fuel-gas exchange section has a fuel transport wick and a gas flow channel; and said fuel retainer and said fuel-gas exchange section satisfy the following relation:
P₂<Pₒ+ρgh<P₇<P₃≦P₁
in which P₁ represents a capillary attraction of said first pore, P₂ represents a capillary attraction of said second pore, P₃ represents a capillary attraction of a pore of said fuel transport wick, P₇ is a capillary attraction of a pore of said fuel retainer, Pₒ represents a force applied from the outside, ρ represents density of a fuel, g represents gravitational acceleration and h represents a maximum head difference in said fuel tank section when said fuel tank section is tilted.

4. The fuel cell according to claim 1, wherein said fuel tank section has a fuel supply port for supplying the fuel.

5. The fuel cell according to claim 1, wherein a gas-liquid separation membrane is formed to said vent hole.

6. Electronic equipment mounting a fuel cell according to claim 1.
